(19) United States
(12) Patent Application Publication
(10) Pub. No.: US 2026/0358661 A1
(43) Pub. Date: Nov. 12, 2026

(54) OPTICAL FILM STRUCTURE, BACKLIGHT MODULE AND DISPLAY

(71) Applicant: Radiant Opto-Electronics Corporation, Kaohsiung City (TW)

(72) Inventors: Jun-Ping LIN, Kaohsiung City (TW); Wei-Hsuan CHEN, Kaohsiung City (TW); Kai-Chun YANG, Kaohsiung City (TW)

(21) Appl. No.: 19/547,697

(22) Filed: Feb. 24, 2026

(30) Foreign Application Priority Data
Mar. 12, 2025 (CN) 202520425564.3

(51) Int. Cl. G02F 1/1335

(52) U.S. Cl. CPC G02F 1/133607

(57) ABSTRACT

An optical film structure including a grating layer and a prism array layer disposed on the grating layer is provided. The grating layer includes a plurality of light-absorbing gratings which are spaced from each other, and each light-absorbing grating extends along a first long axis direction. The prism array layer includes a plurality of transparent prisms, and each transparent prism extends along a longitudinal direction. Each transparent prism includes a fundamental plane disposed on the grating layer, a first plane adjacent to the fundamental plane and a second plane adjacent to the fundamental plane and the first plane. A first angle is between the fundamental plane and the first plane, while a second angle is between the fundamental plane and the second plane. The first angle is unequal to the second angle.

### RELATED APPLICATIONS

This application claims priority to China Application Serial Number 202520425564.3, filed on Mar. 12, 2025, which is herein incorporated by reference in its entirety.

### BACKGROUND

### Technical Field

The present disclosure relates to an optical film structure and relates to a backlight module and a display including the aforementioned optical film structure.

### Description of Related Art

As the competition in vehicle market intensifies, the application of smart cockpits is becoming increasingly widespread. Generally, an in-vehicle display device has a wide viewing angle which allows several users to watch simultaneously. In particular situations, the visible direction and range should be restricted and reduced. Thus, the privacy screen technologies for in-vehicle display device are developed. Current privacy screen technologies restrict the range of light-emitting by incorporating Louvered films into the backlight modules. However, the Louvered films have limited restriction on the light-emitting angle and are difficult to be fine-tuned for specific areas within the visible range, while the privacy protection is especially inadequate in high-brightness environments. In addition, privacy screen technologies also suffer from the high costs and the low efficiency during the manufacturing process at present.

### SUMMARY

Accordingly, an object for the disclosure is to provide an optical film structure, which may adjust the direction of light rays to reduce the light-emitting amount in specific areas, thus helping to improve the privacy protection in those areas.

At least one embodiment of the disclosure provides a backlight module including the aforementioned optical film structure and a light source. The light source is disposed on one side of the optical film structure and configured to emit a light ray to the optical film structure.

At least in one embodiment of the disclosure provides a display including the aforementioned backlight module and a display panel. The display panel is disposed on one side of the backlight module, and the optical film structure of the backlight module is located between the light source and the display panel.

Accordingly, at least one embodiment of the disclosure achieves the privacy protection by incorporating the grating layer or grating sheet into the optical film structure. Furthermore, the prism array layer or the prism array sheet is disposed on the grating layer (or the grating sheet) to change the direction of the light ray passing through it. The refractive property of the prism is utilized to control the direction of the light rays traveling, thereby creating a displacement of the light field to improve the privacy. Therefore, the range of light exiting may be fine-tuned so as to enhance the privacy protection in specific areas.

### BRIEF DESCRIPTION OF THE DRAWINGS

To illustrate more clearly the aforementioned and the other objects, features, merits, and embodiments of the present disclosure, the description of the accompanying figures are as follows:

FIG. 1 illustrates a schematically cross-sectional view of an optical film structure in accordance with one embodiment of the present disclosure;

FIG. 2A illustrates a top view of the light field distribution of a light ray passing through a prior optical film;

FIG. 2B illustrates a top view of the light field distribution of a light ray passing through an optical film structure in accordance with one embodiment of the present disclosure;

FIG. 2C illustrates a light refraction schematic diagram through the first plane of the transparent prism;

FIG. 2D illustrates a cross-sectional view of the transparent prism in accordance with one embodiment of the present disclosure;

FIG. 2E illustrates a relationship between θ1 and φ;

FIG. 2F illustrates a light refraction schematic diagram through the second plane of the transparent prism;

FIG. 3A illustrates a top view of the grating layer in accordance with one embodiment of the present disclosure;

FIG. 3B illustrates a top view of the prism array layer in accordance with one embodiment of the present disclosure;

FIG. 3C illustrates a schematically locally stereoscopic view of the optical film structure in FIG. 1;

FIG. 4 illustrates a schematic cross-sectional view of the optical film structure in accordance with one embodiment of the present disclosure;

FIG. 5 illustrates a schematically locally stereoscopic view of the optical film structure in FIG. 4;

FIG. 6 illustrates a top view of the light field distribution of a light ray passing through the optical film structure in accordance with one embodiment of the present disclosure;

FIG. 7A illustrates a schematically locally stereoscopic view of the optical film structure in accordance with one embodiment of the present disclosure;

FIG. 7B illustrates a top view of the grating layer in accordance with one embodiment of the present disclosure;

FIG. 7C illustrates a top view of the prism array layer in accordance with one embodiment of the present disclosure;

FIG. 8 illustrates a top view of the light field distribution of a light ray passing through the optical film structure in accordance with one embodiment of the present disclosure;

FIG. 9A illustrates a schematically locally stereoscopic view of the optical film structure in accordance with one embodiment of the present disclosure;

FIG. 9B illustrates a top view of the grating layer in accordance with one embodiment of the present disclosure;

FIG. 9C illustrates a top view of the prism array layer in accordance with one embodiment of the present disclosure;

FIG. 10 illustrates a top view of the light field distribution of a light ray passing through the optical film structure in accordance with one embodiment of the present disclosure;

FIG. 11 illustrates a schematically side view of the backlight module in accordance with one embodiment of the present disclosure;

FIG. 12 illustrates a schematically side view of the display in accordance with one embodiment of the present disclosure.

### DETAILED DESCRIPTION

In the following description, the dimensions (such as lengths, widths and thicknesses) of components (such as layers, films, substrates and regions) in the drawings are enlarged not-to-scale, and the number of components may be reduced in order to clarify the technical features of the disclosure. Therefore, the following illustrations and explanations are not limited to the number of components, the number of components, the dimensions and the shapes of components, and the deviation of size and shape caused by the practical procedures or tolerances are included. For example, a flat surface shown in drawings may have rough and/or non-linear features, while angles shown in drawings may be circular. As a result, the drawings of components shown in the disclosure are mainly for illustration and not intended to accurately depict the real shapes of the components, nor are intended to limit the scope of the claimed content of the disclosure.

Further, when a number or a range of numbers is described with “about,” “approximate,” “substantially,” and the like, the term is intended to encompass numbers that are within a reasonable range considering variations that inherently arise during manufacturing as understood by one of ordinary skill in the art. In addition, the number or range of numbers encompasses a reasonable range including the number described, such as within +/−5%, +/−3% or +/−1% of the number described, based on known manufacturing tolerances associated with manufacturing a feature having a characteristic associated with the number. The words of deviations such as “about,” “approximate,” “substantially,” and the like are chosen in accordance with the optical properties, etching properties, mechanical properties or other properties. The words of deviations used in the optical properties, etching properties, mechanical properties or other properties are not chosen with a single standard.

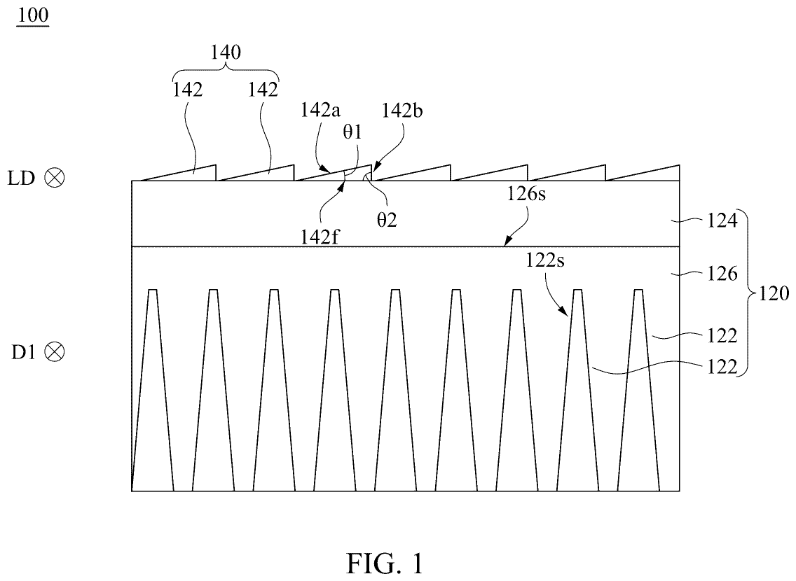

Referring to FIG. 1, an optical film structure 100 includes a grating layer 120 and a prism array layer 140. The grating layer 120 includes a plurality of light-absorbing gratings 122 which are spaced from each other. Each of the plurality of light-absorbing gratings 122 extends along a first long axis direction D1. In addition, the prism array layer 140 is disposed on the grating layer 120. The prism array layer 140 includes a plurality of transparent prisms 142 which are spaced from each other, and each of the plurality of transparent prisms 142 extends along a longitudinal direction LD. The first long axis direction D1 is orthogonal to a second long axis direction D2, while the first long axis direction D1 does not intersect with the longitudinal direction LD.

Furthermore, each of the transparent prisms 142 includes a fundamental plane 142f, a first plane 142a and a second plane 142b. As shown in FIG. 1, the fundamental plane 142f is disposed on the grating layer 120. The first plane 142a is adjacent to the fundamental plane 142f, and the second plane 142b is adjacent to the fundamental plane 142f and the first plane 142a separately. A first angle θ1 is between the fundamental plane 142f and the first plane 142a, while a second angle θ2 is between the fundamental plane 142f and the second plane 142b. It is worth mentioning, the first angle θ1 is unequal to the second angle θ2. For example, when the first angle θ1 in FIG. 1 may be 30°, the second angle θ2 may be 90°.

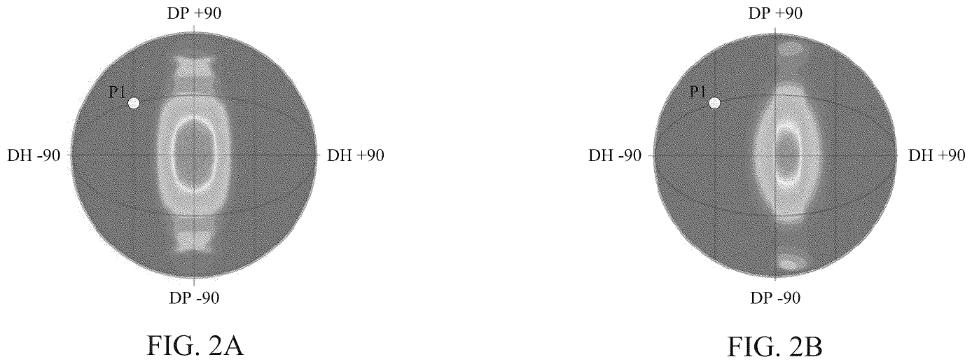

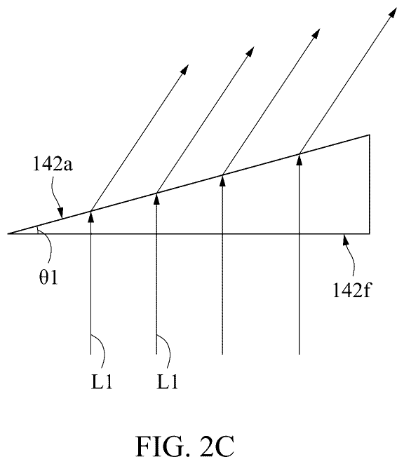

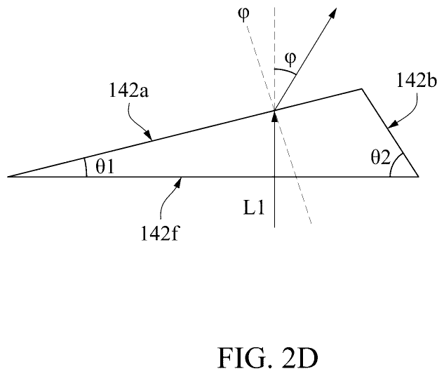

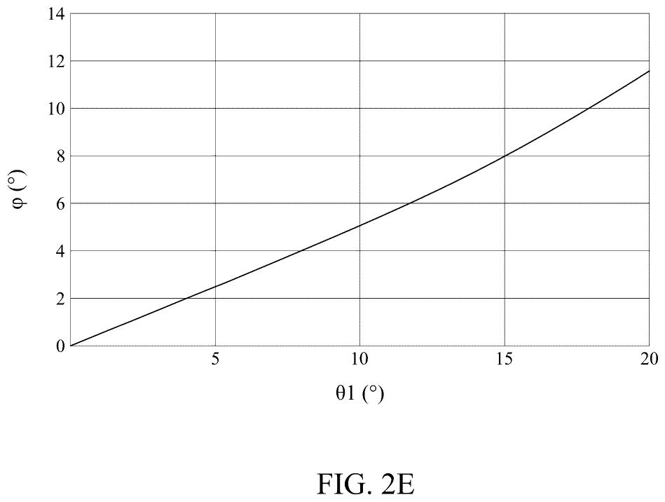

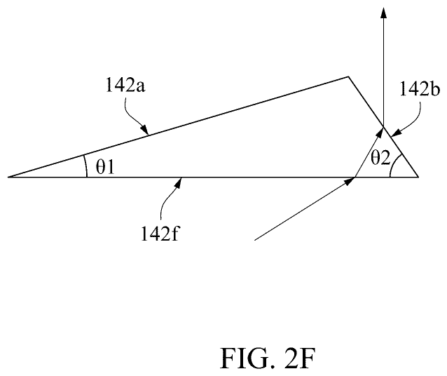

Referring to FIG. 2A and FIG. 2B, where FIG. 2A illustrates the light field distribution of a light ray passing through a prior optical film, and FIG. 2B illustrates the light field distribution of a light ray passing through the optical film structure 100 in accordance with at least one embodiment of the present disclosure. The prior optical film has only a grating layer which has light-absorbing gratings to absorb the light rays with a wide viewing angle and to limit the light exiting within a narrow viewing angle, thereby leading to the privacy protection. However, the optical film structure 100 in the embodiment of the present disclosure includes the prism array layer 140, and the transparent prisms 142 of the prism array layer 140 may change the traveling direction of the light ray. As a result, after the light ray passes through the grating layer 120 and enters the prism array layer 140, the light ray is affected by the transparent prisms 142, so that the light-exiting direction may be changed.

As shown in FIG. 2B, the light field in FIG. 2B is shifted to the right compared to the light field in FIG. 2A. Specifically, the privacy is defined as the luminance at a certain position on the light exiting surface divided by the luminance at the center position on the light exiting surface. The center position of the light exiting surface is defined as 0 degree in a horizontal direction DH and 0 degree in a perpendicular direction DP (H0/V0). To take a position P1 on the light field as an example, the position P1 is at −30 degrees in the horizontal direction DH and at +15 degrees in the perpendicular direction DP (H-30/V15). With the prior optical film, the privacy at the position P1 is 0.62%. On the other hand, with the optical film structure 100 in at least one embodiment of the present disclosure, the privacy at the position P1 is 0.45%, which is 0.27% lower than the prior optical film. That is, the optical film structure 100 in the embodiment may reduce the privacy at specific areas so as to increase the privacy protection in those specific areas.

According to the aforementioned design that the prism array layer 140 is located above the light-absorbing gratings 122, the structural design combines the light absorption and the refraction functions effectively so as to control the light precisely and improve the optical performance, thereby achieving a better privacy protection. The primary difference between the aforementioned design and traditional privacy screens is that traditional privacy screens use the blocking of the light-absorbing gratings to restrict the traveling direction of the light ray. Instead, the prism array layer 140 is added on the basis of the light-absorbing gratings 122 in the embodiment of the disclosure, and the refraction of the prisms is utilized to control the traveling direction of the light ray which achieves a precise light control so as to create a displacement of the light field, thereby improving the privacy protection. Thus, the light exiting range can be fine-tuned to increase the privacy protection in designated areas.

Specifically, referring to FIG. 2C and FIG. 2D, when the light ray L1 enters the transparent prism 142 through the fundamental plane 142f, the light ray L1 exits through the first plane 142a at an light-exiting angle φ, while a refractive index of the transparent prism 142 defined as n satisfies the equation: n×sin θ1=sin(θ1+φ). Thus, a theoretical basis for designing and manufacturing optical film structures with a high-performance is provided. The aforementioned equation ensures accurate calculation of the light refraction, thereby enabling the light to be controlled precisely.

According to the above, the light-exiting angle φ represents the deflection angle of the light field, which may be controlled by the first angle θ1. In particular, when the range of the first angle θ1 is between 0° and 20°, as shown in FIG. 2E, these two are linearly related. A larger first angle θ1 results in a larger light-exiting angle φ, which is the deflection angle of the light field. To take n=1.53 and θ1=10° as an example, the deflection angle is 5.41° which is slightly larger than half of the first angle θ1.

In addition, referring to FIG. 2F, the second angle θ2 controls the direction of the reflected light from the second plane 142b. When the second angle θ2 is between 60° and 90°, the light ray L1 may exit at a more positive angle after being reflected by the second plane 142b, so that it is less likely to exit from other sides, thereby achieving a better privacy protection.

In addition, since a prism array sheet 240 of an optical film structure 200 is nearly identical to the prism array layer 140 of the optical film structure 100 (in terms of materials and structures), a plurality of transparent prisms 242 are also nearly identical to the transparent prisms 142.

Furthermore, the prism array layer 140 in the embodiment is located above the light-absorbing gratings 122, so that the inclined surfaces of the transparent prisms 142, namely the first plane 142a and the second plane 142b, are directly exposed to the air. Thus, the refraction of the light ray caused by the inclined surfaces of the transparent prisms 142 increases, so that the exiting light rays are further away from the normal. As a result, the displacement of the light field may increase significantly. Moreover, the refractive index of the transparent prisms 242 is between 1.46 and 1.62, and the difference between this refractive index range and the refractive index of the air (i.e., approximately 1) leads to a larger deflection as the light rays entering the air from the transparent prisms 242 through a first plane 242a or a second plane 242b. In addition, since the inclined surfaces of the transparent prisms 142 contact the air directly, the light loss and interference introduced by additional media may be prevented, thereby increasing the light transmittance and the stability of optical performance of the optical film structures.

Compared to the design that the prism array layer 140 is located above the light-absorbing gratings 122, the design that the prism array layer is disposed below the light-absorbing grating has some disadvantages. First, the prism array layer below the light-absorbing grating may increase the film thickness so as to affect the overall design and aesthetics of the product. Second, the prism array layer is exposed to the air in this design. Thus, since the refractive index difference between the prism array layer and the light-absorbing grating is smaller than the refractive index difference between the prism array layer and air, the refraction of light rays on the inclined surfaces of the transparent prism is smaller (i.e., the exiting light rays is closer to the normal), resulting in a poorer light field displacement and a less precise light control compared to a design where the prism array layer is located above the light-absorbing grating. As a result, its privacy protection may be poorer than the embodiment of the disclosure. In addition, disposing the prism array layer below the light-absorbing grating also increases the difficulty and the cost of manufacturing the optical films.

Returning to FIG. 1, in some embodiments, the grating layer 120 includes a transparent layer 124. The transparent layer 124 is located between the light-absorbing gratings 122 and the prism array layer 140, while the fundamental plane 142f of each of the transparent prisms 142 is disposed on the transparent layer 124 of the grating layer 120. The transparent layer 124 is used to carrier the prism array layer 140, and the refractive index of the transparent layer 124 may be similar to the refractive index of the transparent prisms 142 in order to reduce the light refraction when the light ray passes through the fundamental plane 142f of the transparent prism 142 from the transparent layer 124 and enters the transparent prism 142. For instance, when the refractive index of the transparent prism 142 is between 1.46 and 1.62, the refractive index of the transparent layer 124 is also between 1.46 and 1.62.

In addition, in some embodiments, the grating layer 120 further includes a transparent material 126. The transparent material 126 is disposed on the light-absorbing gratings 122 and covers a surface 122s of each of the light-absorbing gratings 122. The transparent material 126 is used to protect the surface 122s of the light-absorbing gratings 122 so as to prolong the life of the light-absorbing gratings 122, and the overall optical properties of the optical film structure 100 may be adjusted according to the characteristics of the transparent material 126. On the other hand, a flat surface 126s is formed on the transparent material 126, so that the transparent layer 124 is disposed on the flat surface 126s. Thus, the flatness of the transparent layer 124 may be kept, and the transparent prism 142 of the prism array layer 140 is distributed on the flat transparent layer 124.

It is worth mentioning, the refractive index of the transparent material 126 may be similar to the refractive index of the transparent layer 124 in order to reduce the light refraction when the light ray passes through the flat surface 126s from the transparent material 126 and enters the transparent layer 124. For instance, when the refractive index of the transparent layer 124 is between 1.46 and 1.62, the refractive index of the transparent material 126 is also between 1.46 and 1.62.

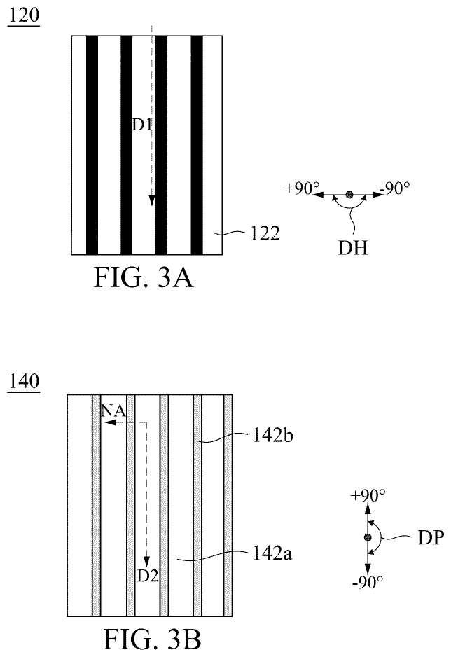

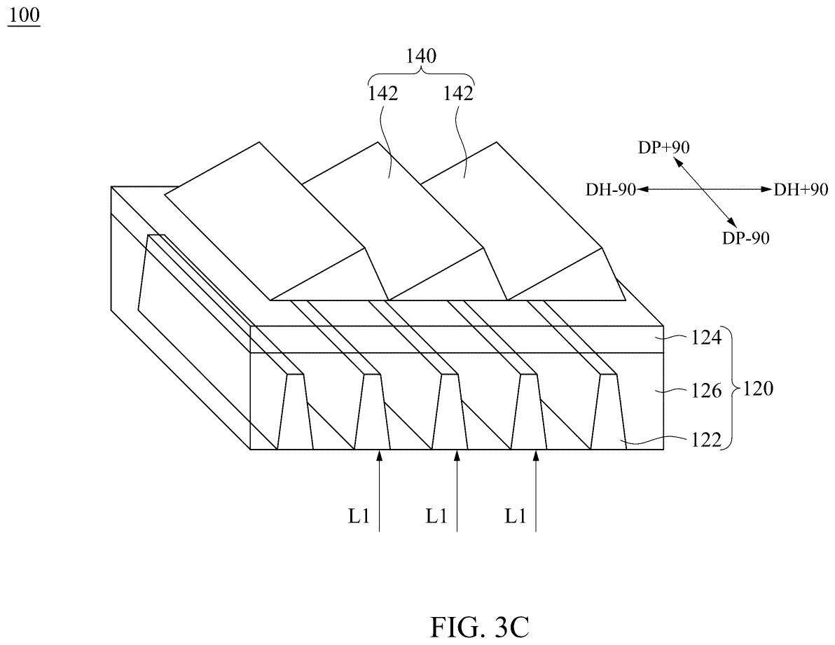

Referring to FIG. 1, FIG. 3A, FIG. 3B and FIG. 3C, FIG. 3A illustrates a top view of the grating layer 120 in FIG. 1, while FIG. 3B illustrates a top view of the prism array layer 140 in FIG. 1, and FIG. 3C illustrates a locally stereoscopic view of the optical film structure 100 in FIG. 1. As shown in FIG. 3A and FIG. 3B, the first long axis direction D1 is orthogonal to the second long axis direction D2, while the first long axis direction D1 does not intersect with the longitudinal direction LD. That is, the extending direction of the light-absorbing gratings 122 of the grating layer 120 in FIG. 1 is parallel to the extending direction of the transparent prisms 142 of the prism array layer 140.

It is worth mentioning, referring to FIG. 2B and FIG. 3C, the top view of the optical film structure 100 in FIG. 3C (i.e., the view from above to below in FIG. 3C) may produce a light field distribution which is equivalent to the one in FIG. 2B with optical simulation. Thus, after the light ray L1 travels from the grating layer 120 to the prism array layer 140 and then exits the prism array layer 140, the light field distribution shown in FIG. 2B is formed. Since the light ray L1 that exits the prism array layer 140 deflects to the right in FIG. 3C, the light field in FIG. 2B also deflects to the right. That is, the light ray L1 deflects to the second plane 142b (i.e., to the second angle θ2).

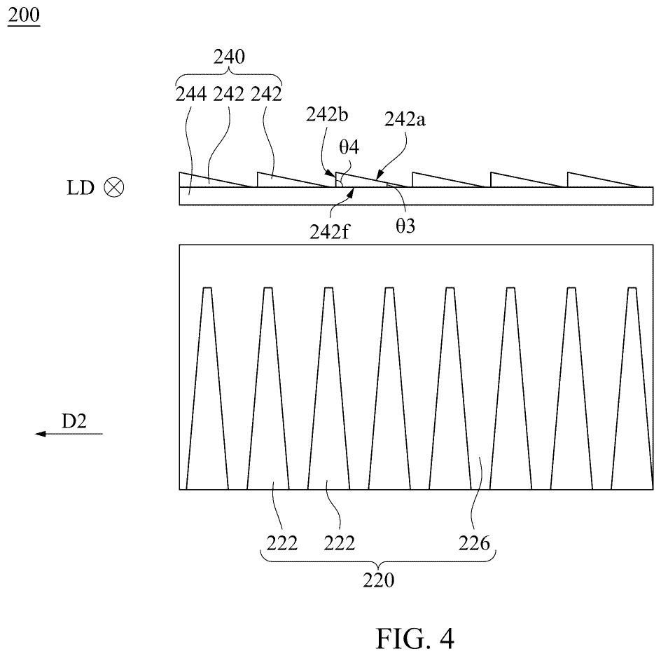

Referring to FIG. 4, another optical film structure 200 in at least one embodiment of the disclosure is provided, which is different from the optical film structure 100 in FIG. 1. The optical film structure 100 in FIG. 1 is an optical film formed by combining the grating layer 120 and the prism array layer 140 with each other. As for the optical film structure 200 in FIG. 4, the grating layer and the prism array layer represent two optical films separated from each other. The two embodiments are functionally identical but structurally different, while both of the embodiments provide superior privacy protection. Two separated optical films may improve the efficiency and reduce the costs in terms of manufacturing and assembly.

In the embodiment, the grating layer of the optical film structure 200 in FIG. 4 may be called a grating sheet 220, while the prism array layer may be called a prism array sheet 240. The grating sheet 220 includes a plurality of light-absorbing gratings 222. These light-absorbing gratings 222 are spaced from each other, while each of the light-absorbing gratings 222 extends along the first long axis direction D1. The prism array sheet 240 is disposed on the grating sheet 220 with an interval and includes a transparent substrate 244 and a plurality of transparent prisms 242. The transparent prisms 242 are spaced from each other on the transparent substrate 244, while each of the transparent prisms 242 extends along the longitudinal direction LD.

In addition, each of the transparent prisms 242 includes a fundamental plane 242f, the first plane 242a and the second plane 242b. The fundamental plane 242f is disposed above and faces the grating sheet 220. The first plane 242a is adjacent to the fundamental plane 242f, while a first angle θ3 is between the fundamental plane 242f and the first plane 242a. The second plane 242b is adjacent to the fundamental plane 242f and the first plane 242a separately, while a second angle θ4 is between the fundamental plane 242f and the second plane 242b, and the first angle θ3 is unequal to the second angle θ4.

Furthermore, the grating sheet 220 further includes a transparent material 226. The transparent material 226 is disposed on the light-absorbing gratings 222 and covers a surface 222s of each of the light-absorbing gratings 222. The transparent material 226 is similar to the transparent material 126, that is, the transparent material 226 is used to protect the surface 222s of the light-absorbing gratings 222. It is worth mentioning, the refractive index of the transparent material 226 may be similar to the refractive index of the transparent substrate 244 in order to reduce the light refraction when the light ray exits from the transparent material 226 and enters the transparent substrate 244. For instance, when the refractive index of the transparent substrate 244 is between 1.46 and 1.62, the refractive index of the transparent material 226 is also between 1.46 and 1.62.

The grating sheet 220 of the optical film structure 200 in the subsequent embodiment is nearly (in terms of materials and structures) the same as the grating layer 120 of the optical film structure 100, while the prism array sheet 240 of the optical film structure 200 is nearly (in terms of materials and structures) the same as the prism array layer 140 of the optical film structure 100. As a result, the relative position between the grating sheet 220 and the prism array sheet 240 may refer to the relative position between the grating layer 120 and the prism array layer 140 in FIG. 3A and FIG. 3B.

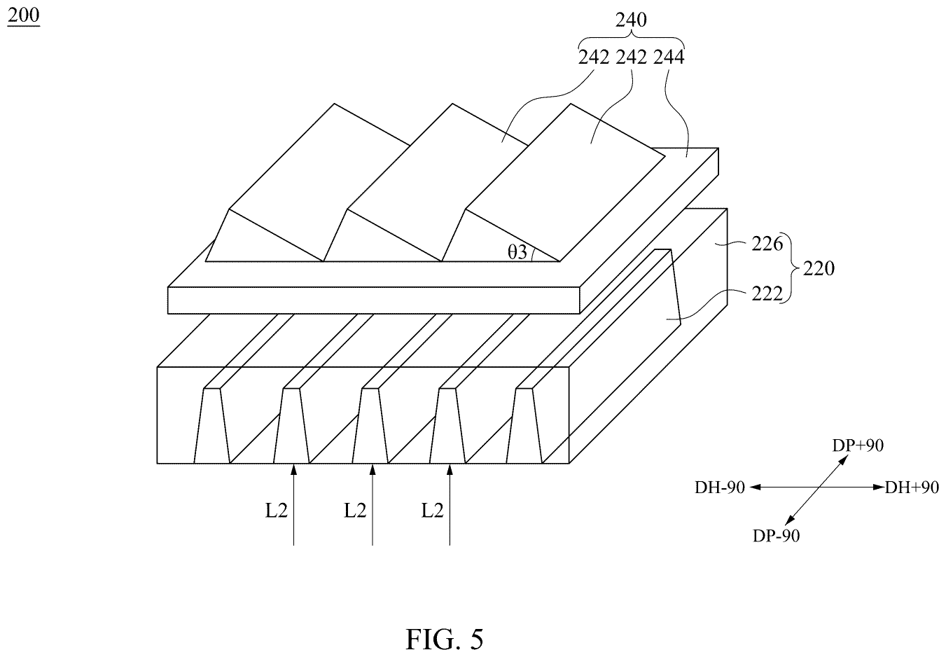

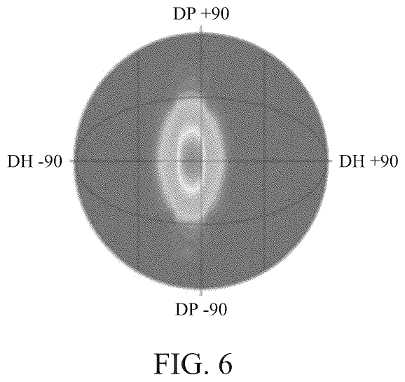

FIG. 5 illustrates the locally stereoscopic view of the optical film structure 200 in FIG. 4, while FIG. 6 illustrates the light field distribution of a light ray passing through the optical film structure 200 in the aforementioned embodiment. Referring to FIG. 2A and FIG. 6, the light field in FIG. 6 is shifted to the left compared to the light field in FIG. 2A (i.e., compared to the prior optical film). The top view of the optical film structure 200 in FIG. 5 (i.e., the view from above to below in FIG. 5) may produce a light field distribution which is equivalent to the one in FIG. 6 with optical simulation. Thus, after the light ray L2 travels from the grating sheet 220 to the prism array sheet 240 and then exits the prism array sheet 240, the light field distribution shown in FIG. 6 is formed. Since the light ray L2 that exits the prism array sheet 240 deflects to the left in FIG. 5, the light field in FIG. 6 also deflects to the left. That is, the light ray L2 deflects to the second plane 242b (i.e., to the second angle θ4).

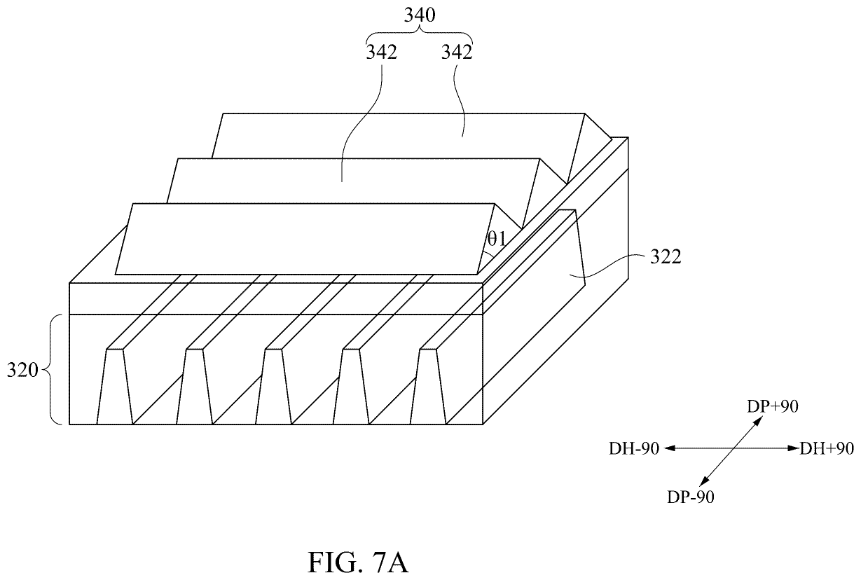

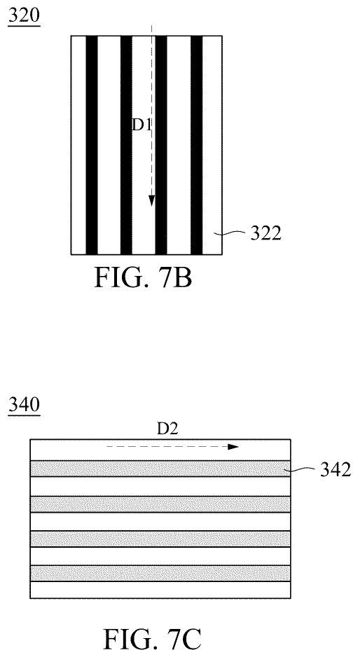

Referring to another embodiment in FIG. 7A, FIG. 7B and FIG. 7C, an optical film structure 300 of the embodiment is similar to the optical film structure 100. Specifically, the optical film structure 300 includes a grating layer 320 and a prism array layer 340, while the grating layer 320 and the prism array layer 340 are substantially equivalent to the grating layer 120 and the prism array layer 140 separately.

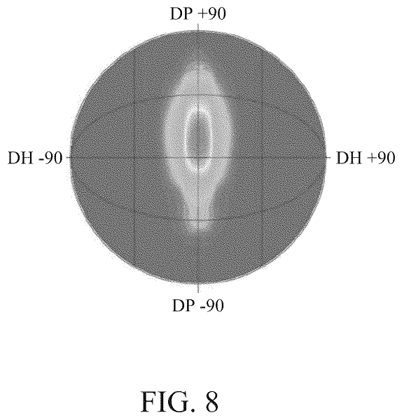

The difference between the optical film structure 100 and the optical film structure 300 is that a plurality of light-absorbing gratings 322 extend along the first long axis direction D1, while a plurality of transparent prisms 342 of the prism array layer 340 extend along the longitudinal direction LD. The first long axis direction D1 is orthogonal to the second long axis direction D2, while the first long axis direction D1 is orthogonal to the longitudinal direction LD. That is, the extending direction of the light-absorbing gratings 322 in the grating layer 320 is orthogonal to the extending direction of the transparent prisms 342 in the prism array layer 340. FIG. 8 illustrates the light field distribution of a light ray passing through the optical film structure 300 in the embodiment. Referring to FIG. 2A and FIG. 8, the light field in FIG. 8 is shifted to the top compared to the light field in FIG. 2A.

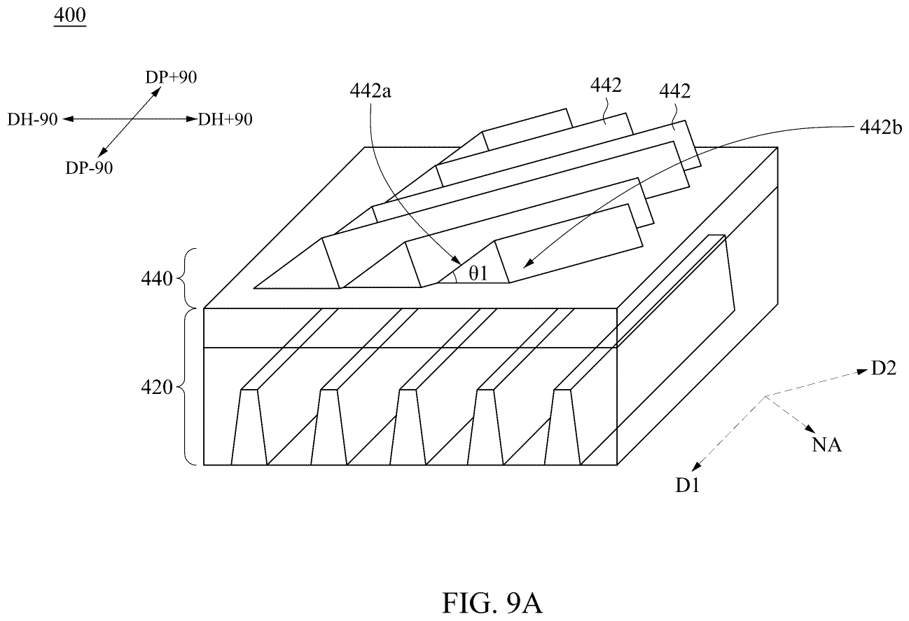

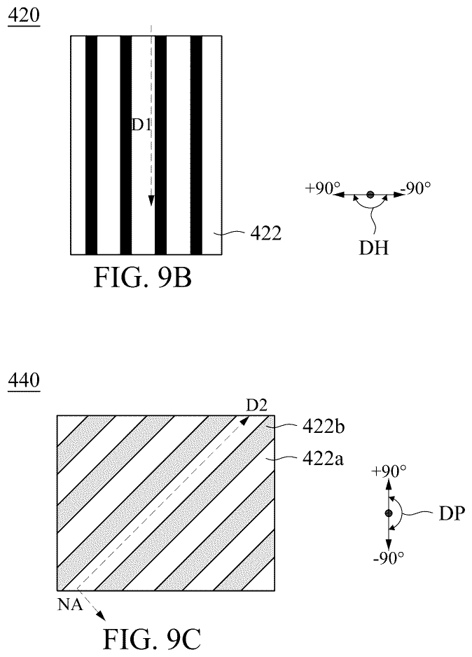

Referring to another embodiment in FIG. 9A, FIG. 9B and FIG. 9C, an optical film structure 400 of the embodiment is similar to the optical film structure 100. Specifically, the optical film structure 400 includes a grating layer 420 and a prism array layer 440, while the grating layer 420 and the prism array layer 440 are substantially equivalent to the grating layer 120 and the prism array layer 140 separately. Although the first long axis direction D1 is orthogonal to the second long axis direction D2 in the embodiment, the first long axis direction D1 intersects with the longitudinal direction LD non-orthogonally. As shown in FIG. 9B, the first long axis direction D1 is between +90° and −90° of the horizontal direction DH, while the second long axis direction D2 is between +90° and −90° of the perpendicular direction DP.

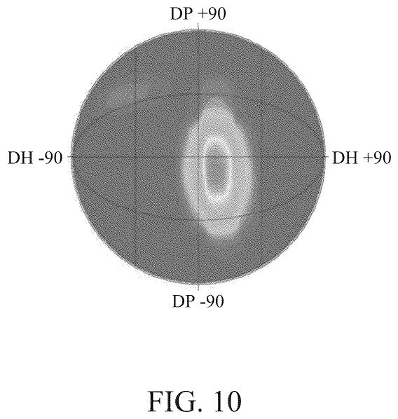

In the embodiment, the first angle θ1 of each of the transparent prisms 442 faces a side close to −90° in the perpendicular direction DP and a side closed to −90° in the horizontal direction DH, while the first angle θ1 is smaller than the second angle θ2. In other words, the angle between the normal direction NA of a first plane 442a of the transparent prism 442 and the −90° in the perpendicular direction DP is an acute angle, while the angle between the normal direction NA of the first plane 442a of the transparent prism 442 and the −90° in the horizontal direction DH is an acute angle. FIG. 10 illustrates the light field distribution of a light ray passing through the optical film structure 400 in the embodiment. Referring to FIG. 2A and FIG. 10, the light field in FIG. 10 is shifted to the bottom right compared to the light field in FIG. 2A. That is, the deflection of the light field is the same as the normal direction NA of the first plane 442a.

However, the orientation of the first angle θ1 in the disclosure is not limited to the aforementioned embodiment. In other embodiments (without illustration), the first angle θ1 of each of the transparent prisms 442 may face a side close to +90° in the horizontal direction DH and a side closed to +90° in the perpendicular direction DP, while the first angle θ1 is smaller than the second angle θ2. In other words, the angle between the normal direction NA of the first plane 442a of the transparent prism 442 and the +90° in the horizontal direction DH is an acute angle, while the angle between the normal direction NA of the first plane 442a of the transparent prism 442 and the +90° in the perpendicular direction DP is also an acute angle. As a result, the consequence which is contrary to FIG. 10 is formed, that is, the light filed is shifted to the top left.

It is worth mentioning, even when the first long axis direction D1 does not intersect with the longitudinal direction LD, the deflecting direction of the light field may be changed by adjusting the angle between the normal direction NA of the first plane 142a and the perpendicular direction DP (or the horizontal direction DH), which causes the difference of the light fields between FIG. 2B and FIG. 6.

For instance, referring to FIG. 3A, FIG. 3B and FIG. 3C, the first angle θ1 of each of the transparent prisms 142 faces a side close to −90° in the horizontal direction DH. In other words, the first angle θ1 of the transparent prism 142 faces the right of FIG. 3B, while the angle between the normal direction NA of the first plane 142a of the transparent prism 142 and the +90° in the perpendicular direction DP is a right angle. The first angle θ1 is smaller than the second angle θ2, and this embodiment may form the light field shown in FIG. 2B, where the light field is shifted to the right. In addition, although it is not illustrated in figures, when the first angle θ1 of each of the transparent prisms 142 faces a side close to +90° in the horizontal direction DH, and the first angle θ1 is smaller than the second angle θ2, that is, the first angle θ1 of the transparent prism 142 is toward the left of FIG. 3B, the light field shifted to the left in FIG. 6 is formed.

It is worth mentioning, at least one embodiment of the disclosure may be similar to the optical film structure 200 in FIG. 4 and FIG. 5 even though it is not illustrated in figures. The difference between the optical film structure of this embodiment and the optical film structure 200 is that the first long axis direction D1 is orthogonal to the second long axis direction D2, while the first long axis direction D1 is orthogonal to the longitudinal direction LD. That is, the extending direction of the light-absorbing gratings 222 of the grating sheet 220 is orthogonal to the extending direction of the transparent prisms 242 of the prism array sheet 240. FIG. 8 illustrates the light field distribution of a light ray passing through the optical film structure 200. Referring to FIG. 2A and FIG. 8, the light field in FIG. 8 is shifted to the top compared to the light field in FIG. 2A.

Specifically, as shown in FIG. 7A, when the first long axis direction D1 is orthogonal to the longitudinal direction LD, the first angle θ1 of each of the transparent prisms 142 faces a side close to −90° in the perpendicular direction DP. In other words, the first angle θ1 of the transparent prism 142 is toward the top of FIG. 7C, so that the light field shifted to the top in FIG. 8 is formed. On the other hand, although it is not illustrated in figures, when the first angle θ1 of each of the transparent prisms 142 faces a side close to +90° in the perpendicular direction DP, that is, the first angle θ1 of the transparent prism 142 is toward the bottom of FIG. 7C, the light field shifted to the bottom is formed.

Furthermore, although it is not illustrated in figures, another embodiment of the disclosure may also be similar to the optical film structure 200 in FIG. 4 and FIG. 5. The difference between the optical film structure of the embodiment and the optical film structure of the optical film structure 200 is that the first long axis direction D1 is orthogonal to the second long axis direction D2, but the first long axis direction D1 intersects with the longitudinal direction LD non-orthogonally. Specifically, the first long axis direction D1 is between +90° and −90° of the horizontal direction DH, while the second long axis direction D2 is between +90° and −90° of the perpendicular direction DP (referring to FIG. 9B and FIG. 9C).

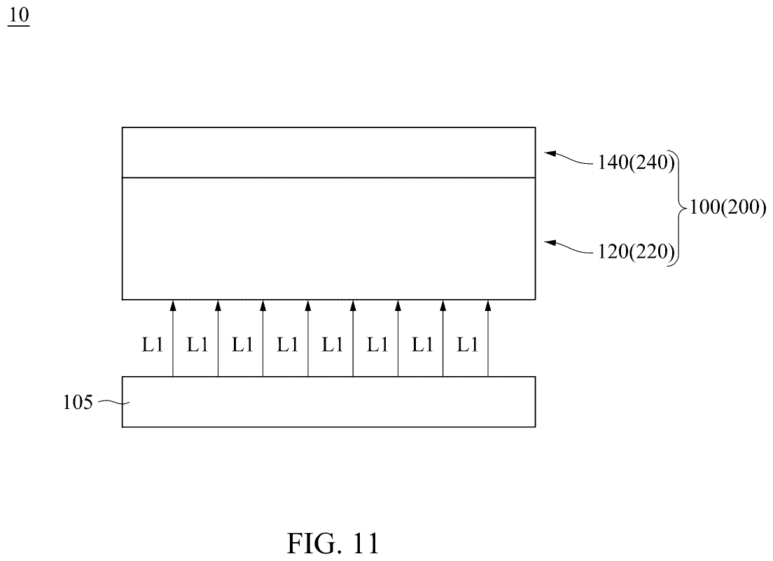

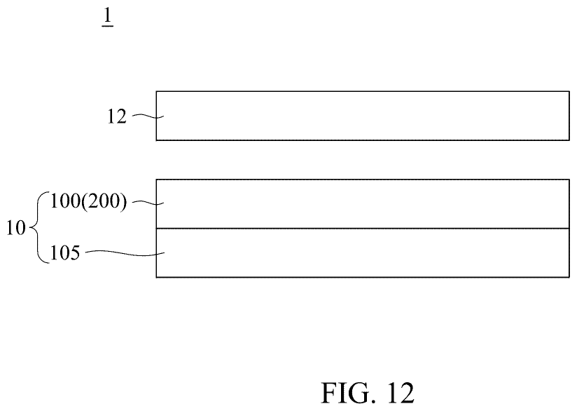

Referring to a backlight module 10 illustrated in FIG. 11, the backlight module 10 includes the aforementioned optical film structure 100 (or the optical film structure 200) and a light source 105. The light source 105 is located at one side of the optical film structure 100 (or the optical film structure 200) and is used to emit the light ray L1 to the optical film structure 100 (or the optical film structure 200). The grating layer 120 (or the grating sheet 220) is located between the prism array layer 140 (or the prism array sheet 240) and the light source 105.

Referring to a display 1 illustrated in FIG. 12, the display 1 includes the aforementioned backlight module 10 and a display panel 12. The display panel 12 is located at one side of the backlight module 10. The optical film structure 100 (or the optical film structure 200) of the backlight module 10 is located between the light source 105 and the display panel 12.

In conclusion, the privacy protection is achieved by incorporating the grating layer or grating sheet into the optical film structure. Furthermore, the prism array layer or prism array sheet is disposed on the grating layer (or grating sheet) to change the direction of the light ray passing through it, thereby reducing the light emission in specific areas. Therefore, the range of light exiting may be fine-tuned so as to enhance the privacy protection in specific areas.

Although the embodiments of the present disclosure have been disclosed as above in the embodiments, they are not intended to limit the embodiments of the present disclosure. Any person having ordinary skill in the art can make various changes and modifications without departing from the spirit and the scope of the embodiments of the present disclosure. Therefore, the protection scope of the embodiments of the present disclosure should be determined according to the scope of the appended claims.

What is claimed is:

1. An optical film structure, comprising:
a grating layer comprises:
a plurality of light-absorbing gratings spaced from each other, wherein each of the plurality of light-absorbing gratings extends along a first long axis direction; and
a prism array layer disposed on the grating layer and comprising:
a plurality of transparent prisms spaced from each other, wherein each of the plurality of transparent prisms extends along a longitudinal direction, and each of the plurality of transparent prisms comprises:
a fundamental plane disposed on the grating layer;
a first plane adjacent to the fundamental plane, wherein a first angle is between the fundamental plane and the first plane; and
a second plane adjacent to the fundamental plane and the first plane separately, wherein a second angle is between the fundamental plane and the second plane, and the first angle is unequal to the second angle.

2. The optical film structure of claim 1, wherein the grating layer further comprises a transparent layer located between the plurality of light-absorbing gratings and the prism array layer, and the fundamental plane of each of the plurality of transparent prisms is disposed on the transparent layer of the grating layer.

3. The optical film structure of claim 1, wherein the grating layer further comprises:
a transparent material disposed on the plurality of light-absorbing gratings and covering a surface of each of the plurality of light-absorbing gratings.

4. The optical film structure of claim 1, wherein the first long axis direction is orthogonal to a second long axis direction, and the first long axis direction intersects with the longitudinal direction non-orthogonally.

5. The optical film structure of claim 4, wherein the second long axis direction is between +90° and −90° of a horizontal direction, and the first long axis direction is between +90° and −90° of a perpendicular direction, wherein the first angle of each of the plurality of transparent prisms faces a side close to −90° in the perpendicular direction and a side close to −90° in the horizontal direction, and the first angle is smaller than the second angle.

6. The optical film structure of claim 1, wherein the first long axis direction is orthogonal to a second long axis direction, and the first long axis direction is orthogonal to the longitudinal direction.

7. The optical film structure of claim 6, wherein the first long axis direction is between +90° and −90° of a perpendicular direction, and the first angle of each of the plurality of transparent prisms faces a side close to +90° or −90° in the perpendicular direction, wherein the first angle is smaller than the second angle.

8. The optical film structure of claim 1, wherein the first long axis direction is orthogonal to a second long axis direction, and the first long axis direction does not intersect with the longitudinal direction.

9. The optical film structure of claim 8, wherein the second long axis direction is between +90° and −90° of a perpendicular direction, and the first angle of each of the plurality of transparent prisms faces a side close to −90° or +90° in a horizontal direction, wherein the first angle is smaller than the second angle.

10. The optical film structure of claim 1, wherein the first angle is between 0° and 20°, and the second angle is between 60° and 90°.

11. The optical film structure of claim 1, wherein when a light ray enters the plurality of transparent prisms through the fundamental plane, the light ray exits through the first plane at a light-exiting angle, wherein the first angle defined as θ1, and the light-exiting angle defined as φ, and a refractive index of the transparent prism defined as n satisfies an equation: n×sin θ1=sin(θ1+φ).

12. The optical film structure of claim 1, wherein the first plane and the second plane of each of the plurality of transparent prisms are exposed to the air.

13. The optical film structure of claim 1, wherein the grating layer and the prism array layer are combined with each other to form an optical film.

14. The optical film structure of claim 1, wherein the grating layer and the prism array layer represent two optical films separated from each other.

15. A backlight module, comprising:
the optical film structure of claim 1; and
a light source disposed on one side of the optical film structure, wherein the grating layer is located between the prism array layer and the light source.

16. A display, comprising:
the backlight module of claim 15; and
a display panel disposed on one side of the backlight module, wherein the optical film structure of the backlight module is located between the light source and the display panel.
